(19) United States
(12) Patent Application Publication
(10) Pub. No.: US 2026/0333502 A1
(43) Pub. Date: Oct. 22, 2026

(54) NETWORK ACCESS OPTIMIZATIONS IN A PRIVATE 5G NETWORK TO ADDRESS PLMN ID COLLISION

(71) Applicant: HEWLETT PACKARD ENTERPRISE DEVELOPMENT LP, Spring, TX (US)

(72) Inventors: PINGPING ZONG, Spring, TX (US); Paolo Missiaggia, Milano (IT); Amogh Guruprasad Deshmukh, Santa Clara, CA (US)

(21) Appl. No.: 19/185,563

(22) Filed: Apr. 22, 2025

(51) Int. Cl. H04W 76/27; H04W 8/26

(52) U.S. Cl. CPC H04W 76/27; H04W 8/26

(57) ABSTRACT

Systems and methods are provided for improved network acquisition procedures by a user equipment (UE) on private networks to perform initial registration, mobility registration, periodic registration or service request. For example, a base station can route a UE's signaling to an AMF of a GUAMI. If the base station does not recognize the reported GUAMI, the base station may decide that the UE is a non-subscribing UE, and it should release this UE's RRC connection using a RRC connection release procedure. In another example, the UE may exchange Non-Access Stratum (NAS) information, comprising the GUAMI, with the AMF. The AMF can be configured with an approved list of GUAMIs and can check if the UE's GUAMI belongs to the list of the supported ones. In case the GUAMI is not recognized, the UE can be rejected.

### BACKGROUND

There are innumerable communication-ready devices on cellular networks. To help manage the communications for a user device or user equipment (UE) on public networks, public mobile carriers are assigned unique identifiers. These unique identifiers are typically assigned by the International Telecommunication Union (ITU) or a national/regional governing authority. The unique identifiers are assigned to each public network provider, and the public network provider can provide the unique identifier to a UE in order to enable use of the network by the UE.

When the UE searches for its network, it can provide a unique identifier that allows the UE to be matched to the public network provider. The public network provider and its corresponding network components, like base stations, Access and Mobility Management Function (AMF), and Unified Data Management (UDM), can identify whether the UE is permitted to transmit communications on its network.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example communications system within which examples of the disclosed technology may be implemented.

FIG. 2 illustrates an example message flow, in accordance with examples of the disclosed technology.

FIG. 3 illustrates an example message flow, in accordance with examples of the disclosed technology.

FIG. 4 illustrates an example registration process, in accordance with examples of the disclosed technology.

FIG. 5 is an example computing component that may be used to implement various features of examples of the disclosed technology.

FIG. 6 illustrates an example message flow, in accordance with examples of the disclosed technology.

FIG. 7 is an illustrative 3GPP 5G-GUTI data format, in accordance with examples of the disclosed technology.

FIG. 8 illustrates an example registration process, in accordance with examples of the disclosed technology.

FIG. 9 is an example computing component that may be used to implement various features of examples of the disclosed technology.

FIG. 10 is an example computing component that may be used to implement various features of examples of the disclosed technology.

FIG. 11 depicts a block diagram of an example computer system in which various examples of the disclosed technology described herein may be implemented.

The figures are not exhaustive and do not limit the present disclosure to the precise form disclosed.

### DETAILED DESCRIPTION

In some current communication networks, the network may be assigned a global unique Public Land Mobile Network (PLMN) identity (ID). The PLMN ID can be broadcast by the base station to UEs within the network's coverage. Once a PLMN ID is received and decoded, a UE can compare the received PLMN ID against its stored PLMN IDs to determine whether the detected network belongs to the UE's home PLMN or equivalent PLMN, and hence whether it should try to request access to the detected network.

The PLMN ID contains a 3-digit Mobile Country Code (MCC) and a 2- to 3-digit Mobile Network Code (MNC). The MCC and MNC assignment is managed by ITU-T and each region's regulatory bodies, respectively, to ensure the globally unique PLMN ID(s) being assigned to the mobile network operators (MNO).

Various “base stations” are described herein and, in some examples, the descriptions of these base stations may be interchangeable based on the type of network that is implemented, without diverting from the essence of the disclosed technology. For example, gNodeB or gNB is the 5G radio base station that connects 5G New Radio (NR) UEs to the 5G core network using the NR radio interface. ng-eNodeB is a 4G LTE radio base station that connects 4G LTE devices to the 5G core network using the LTE radio interface. eNodeB or eNB is the Long-Term Evolution (LTE) radio base station that connects the LTE-supported UEs to the 4G core network. Some base stations may operate in the frequency spectrum of 5G, including the low-band spectrum, i.e., the sub-1 GHz spectrum; the mid-band spectrum, i.e., the sub-6 GHz spectrum; and/or the high-band spectrum, e.g., millimeter wave (mmWave) that operates between 25 GHz and 100 GHz.

However, only a handful of PLMN IDs have been allocated by the governing authorities to be used by the private networks around the world, resulting in private network operators sharing PLMN IDs. In other words, the private operators do not have access to their own unique PLMN ID. Rather, the PLMN ID is defined by geography and shared across multiple private network operators in a particular geographical region (e.g., including 262-98 in Germany; 240-41, 240-49, 240-65 and 240-66 in Sweden; and 315-010 in the U.S.).

Due to the potential large number of private networks that exist and the lack of centralized control in managing the PLMN IDs for each of these private network, it becomes difficult for each private network to use the PLMN ID to distinguish itself from other private networks in the same geographical region. For example, in the U.S. currently, there are thousands of private networks that are deployed on a particular spectrum that share the same PLMN ID. When the UE attempts to attach to the private network based on the detection of the network's PLMN ID that is broadcast by the base station for a private network, the UE is unable to determine if the broadcast PLMN ID belongs to a preferred network or to a private network that it does not have a subscription to.

By preventing the UE from making this initial determination, the UE may initiate attempts to acquire network access to the private networks that it does not belong, which may eventually fail. The attempts to acquire network access may include transmitting multiple unnecessary communications to those networks, which can be wasteful for over-the-air resources and processing capabilities of the network components (e.g., base stations, AMF, and UDM) in those networks that are configured to process these requests. As such, the lack of sufficient number of private network PLMN IDs to distinguish the private network from each other can lead to the PLMN ID collision of the communications that use overlapping PLMN IDs between private cellular networks (e.g., multiple private networks that use the same PLMN ID).

The present disclosure provides multiple examples to modify the behaviors or infrastructure of the current communication network framework in handling UE's network attachment request in order to minimize the waste of the network resources.

A first example illustrates an improved network acquisition procedure when the UE performs initial registration, mobility registration, periodic registration, or service request. The acquisition procedure may be initiated by the UE. For example, the UE may provide a Globally Unique AMF ID (GUAMI) in the Radio Resource Control (RRC) SETUP COMPLETE message as specified in section 5.3.3.4 of TS 38.331 in a 5G communication system. This GUAMI is the identifier of the AMF that the UE may have registered to in its previous 5G session. The base station may then route the UE's signaling to the AMF of this GUAMI. If the base station does not recognize the reported GUAMI from the UE, the base station may decide that the UE is a non-subscribing UE, and it should release this UE's RRC connection using a RRC connection release procedure as defined in section 5.3.8 of TS 38.331. Thus, by releasing UE's RRC connection, the over-the-air resources and the processing capacities of the network components (e.g., base station, AMF, and UDM) that are configured to process these requests are not wasted.

In some examples, the list of GUAMIs may contain native-type and mapped-type GUAMIs. The native-type may correspond to no changes in the value of the GUAMI, even after a communication system change and the mapped-type may correspond to a change in the value of the GUAMI after a communication system change. The existence of the native/mapped indications of the GUAMI can be used by the AMF to distinguish the type of the communication system that the UE was registered to in the previous successful registration. The determination may be performed based on an explicit indication sent from the UE to the base station in RRC Setup Complete message and further relayed by the base station to the AMF in the Initial UE Message.

In some examples, the UE may provide a mapped-type GUAMI instead of a native-type GUAMI in the RRC SETUP COMPLETE message. This GUAMI may be mapped from a Global Unique Mobility Management Entity (MME) Identifier (GUMMEI), which correspond to the identifier of the MME that the UE may have registered to in its previous session. The base station can route the UE's signaling to the MME of this GUMMEI. If the base station does not recognize the reported mapped-type GUAMI from the UE, the base station may decide that the UE is a non-subscribing UE, and it should release this UE's RRC connection using a RRC connection release procedure. Thus, by releasing UE's RRC connection, the over-the-air resources and the processing capacities of the network components (e.g., base stations, MME, HSS/HLR, and UDM) that are configured to process these requests are not wasted.

In some examples, the base station may configure the UE to not attempt further network acquisition in the same base station coverage for certain period of time by including a waitTime parameter to set UE's T302 timer which is defined in section 7.1 of TS 38.331. Therefore, the UE can be prevented from transmitting multiple, unnecessary communications to the network components to attempt to acquire network access.

In some examples, the base station is configured by its serving AMF with a full list of GUAMIs of AMFs in a Next Generation (NG) Setup procedure or AMF Configuration Update procedure as specified in section 8.7.1 and section 8.7.3 of TS 38.413, respectively. The list of GUAMIs may include the identities of the roaming partner networks' AMFs to support subscribers roaming between 5G private enterprise networks, and the mapped-type of GUAMIs of the MMEs, as specified in section 2.10.2 of TS 23.003, to support subscribers roaming from 4G networks to 5G networks.

In other examples, the base station is configured by its serving MME with a full list of GUMMEI of MMEs in a S1 setup procedures or MME Configuration Update procedure as specified in section 8.7.3 and section 8.7.5 of TS36.413, respectively. The list of GUMMEIs may include the identities of the roaming partner networks' MMEs to support subscribers roaming between 4G private enterprise networks, and the mapped-type of GUMMEIs of the AMFs, as specified in section 2.10.2 of TS 23.003, to support subscribers roaming from 5G networks to 4G networks.

A second example also effectuates an improved network acquisition procedure when the UE performs initial registration, mobility registration, or periodic registration (e.g., by submitting a registration request to the AMF/MME). The procedure may be initiated by the UE. For example, the UE may exchange Non-Access Stratum (NAS) information with the AMF or MME. The NAS information may be encapsulated in the RRC SETUP COMPLETE message over-the-air between UE and base station and in the Initial UE Message over NG or S1 interface between base station and AMF or MME, as specified in section 5.3.3.4 of TS 38.331 or TS 36.331, and section 8.6.1 of TS 38.413 or section 8.6.2.1 of TS 36.413, respectively. The NAS information can comprise a UE's 5G Globally Unique Temporary Identifier (5G-GUTI) or GUTI that the UE obtains from a previous successful registration with its 5G home PLMN or 4G home PLMN. 5G-GUTI contains the GUAMI information as specified in section 5.9.4 of TS 23.501 and GUTI contains the GUMMEI information as specified in section 5.2.2 of TS 23.401. In this example, the AMF or MME can be configured with an approved list of GUAMIs (or an approved list of GUMMEIs) and can check if the UE's GUAMI or GUMMEI belongs to the list of the supported ones. In case the GUAMI or GUMMEI is not recognized, the UE can be rejected, without further consuming radio access network (RAN) or core network (CN) resources. The rejection may be implemented using Cause #15 “No suitable cells in tracking area” to allow the UE to try acquiring access to a network in different tracking areas, as specified in section 5.5.1 of TS 24.501 or TS 23.501. The rejection may be implemented using the cause other than Cause #15, if appropriate. Thus, the AMF or MME can initiate the rejection of the UE's registration requests and further instruct the base station to release UE's RRC connection. It may help prevent the UE from transmitting multiple, unnecessary communications to the RAN or CN resources. This can also help preserve over-the-air resources and processing capacities of the network components. The list of GUAMIs or GUMMEI may include the identities of the roaming partner networks' AMFs (or MMEs) to support subscribers roaming between private enterprise networks, and/or the mapped-type of GUAMIs of the MMEs (or the mapped-type of GUMMEIs of the AMFs), in a 4G (or 5G) communication systems of the roaming partners.

Technical improvements are realized throughout the disclosure. For example, both the first and second examples can improve network handling by reducing the number of the communications being transmitted at least between the UE, base station, and AMF. The reduced communications can also lead to a signal load reduction in both the air interface and the network resource. Additionally, the UDM and other devices of the core/central logic network may not be contacted by the non-subscribing UE's network acquisition attempts. The UDM may be configured to handle all subscribing UEs' registration, authorization, and authentication procedure, so the reduction in communications to this device may improve the overall network stability and reliability by helping to prevent a UDM outage due to signaling overload.

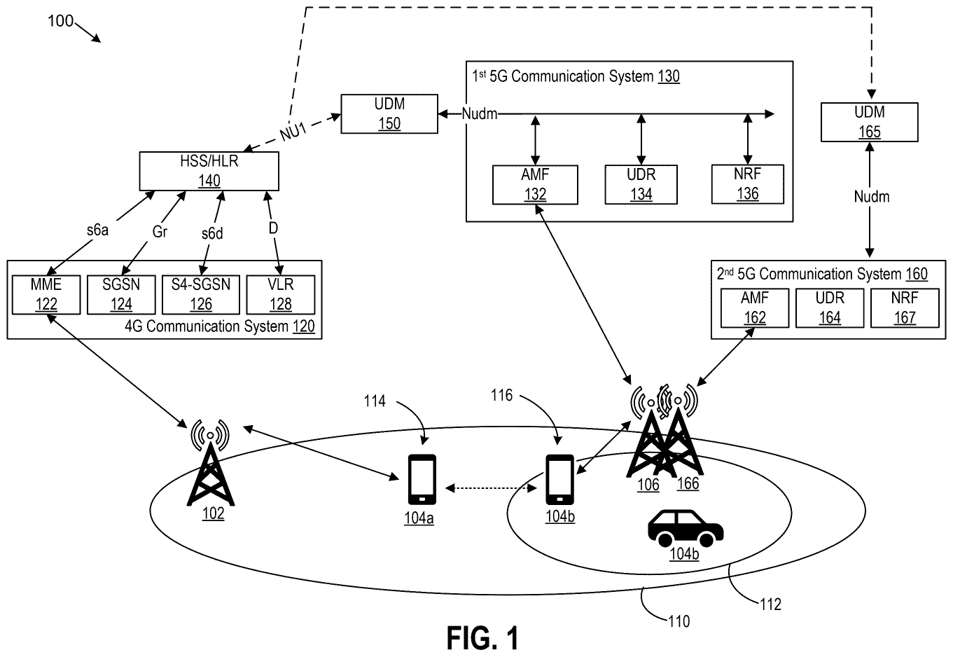

FIG. 1 is an illustrative cellular communication system 100 with which various examples of the present disclosure may be implemented. The cellular communications system 100 may comprise three private networks, including 4G communication system 120 and first 5G communication system 130, who are roaming partners, and second 5G communication system 160, who has no partnership with 4G communication system 120 and first 5G communication system 130.

Various components of cellular communication system 100 are also illustrated, including a plurality of base stations or cells (e.g., base stations 102, 106, 166) and user equipment (UE) 104 (including UE 104a and UE 104b). Base stations 102, 106, 166 may include macrocells (high power cellular base station) and/or small cells (low power cellular base station). In the illustrative example of FIG. 1, base station 102 is configured according to 4G/LTE standards and interfaces with the 4G communication system 120 through an S1 interface. Base stations 106, 166 are configured according to 5G standards and interfaces with first 5G communication system 130 and second 5G communication system 160 through an N1/N2 interface.

Base stations 102, 106, 166 may wirelessly communicate with one or more UEs 104. For example, each of base stations 102, 106, 166 may provide communication coverage for a respective geographic coverage area 110 and 112, respectively. In some scenarios, such geographic coverage areas may overlap. For example, base station 102 may have a coverage area 110 that overlaps the coverage area 112 of one or more other base stations, such as base station 106 as shown.

While a single base station 102 (e.g., a 4G/LTE configured base station) and two base stations 106, 166 (e.g., a 5G configured base station) are illustrated, the cellular communication systems disclosed herein are not limited thereto. One or more base stations 102 and/or one or more base stations 106 may be provided. For example, a plurality of base stations 102 may be provided, each having a respective coverage area 110. One or more of the respective coverage areas 110 may overlap. Similarly, a plurality of base stations 106 may be provided, each having a respective coverage area 112. One or more of the respective coverage areas 112 may overlap. Furthermore, one or more coverage areas 110 may overlap with one or more coverage areas 112.

4G communication system 120 includes various network function entities, including, for example but not limited to, one or more MMEs 122, a Serving Gateway (S-GW) (not shown), a Packet Data Network (PDN) Gateway (not shown), among other network function entities. In some examples, MMEs 122 can be used herein to refer to one or more of an MME, Serving General Packet Radio Service (GPRS) Support Node (SGSN), S4-SGSN (e.g., a SGSN that can interface with 4G network), Visitor Location Register (VLR), or similar network function entity included in the 4G communication system. “Legacy mobility management device” can also be used herein to refer to one or more of SGSN, S4-SGSN, VLR and the like. Additionally, “location and service information interface” may be used to refer to one or more of the S6a, s6d, D, Gr, or similar interfaces between the HSS and a respective mobility management device. Although MME 122 is illustrated in FIG. 1, this device may correspond to any type of mobility management device and these terms are used interchangeably throughout the disclosure.

Each MME 122 may be in communication with a Home Subscriber Server (HSS) 140 over a designated interface, for example, an S6a interface used for exchange of authentication, location, and server information about subscribers between the HSS 140 and MME 122. Each MME 122 may function as a control node that processes signaling between the UEs 104 and the 4G communication system 120, including providing bearer and connection management functionality. The Packet Data Network (PDN) Gateway may be connected to IP Services, such as the Internet, an intranet, an IP Multimedia Subsystem (IMS), a Packet-Switched (PS) Streaming Service, and/or other IP services.

The Network Functions (NFs) of 4G communication system 120 may be implemented as computing systems, such as one or more servers. The NFs of the EPC 120 may communicate using protocols, such as the Diameter Protocol and/or Mobile Application Part (MAP) of the SS7 protocol. For example, the Diameter Protocol may be used for messages between the MME and the HSS or an S4-SGSN and the HSS, while MAP may be used for messages between a Home Location Repository (HLR) and a SGSN or VLR. Data included in the messages on the 4G communication system may be formatted according to American Standard Code for Information Interchange (ASCII) protocols.

First 5G communication system 130 may include various virtualized NFs, including, for example but not limited to, an Authentication Server Function (AUSF) (not shown), AMF 132, a policy control function (PCF) (not shown), a session management function (SMF) (not shown), a Unified Data Repository (UDR) 134, and a Network Repository Function (NRF) 136, to name a few. For example, AMF 132 may be the control node that processes the signaling between UEs 104, via base station 106 and first 5G communication system 130.

AMF 132 may receive connection and mobility management tasks from UEs 104 and can handle connection and mobility management tasks, while forwarding session management tasks/messages to a Session Management Function (SMF). AMF 132 may be in communication with UDM 150 over a service-based interface (SBI) for UDM 150, such as a Nudm interface.

First 5G communication system 130 may also include NRF 136, which provides for network function service registration, authorization, and discovery, and otherwise enables network functions to identity one another. First 5G communication system 130 may also include a User Plane Function (UPF) (not shown) that is connected to IP Services, which may include the Internet, an intranet, an IMS, a PS Streaming Service, and/or other IP services.

The NFs of first 5G communication system 130 may be implemented as computing systems, such as one or more servers. The NFs of first c5G communication system 130 may communicate using protocols, such as HyperText Transfer Protocol (HTTP). Communications and operations may be sent, for example, using HTTP methods, such as POST, PATCH, GET, PUT, etc.

As noted herein, AMF 132 may receive connection and session-related information from UEs across N1/N2 reference point interfaces (between UE and AMF/between RAN and AMF), and may handle connection and mobility management tasks. That is, an AMF instance may be specified to a UE, e.g., UE 104a or 104b, in a NAS message that is routed to the AMF instance by the RAN. Performing the role of an access point to the 5G core network (terminating the RAN and UE control plane traffic), the AMF instance may authenticate the UE and manage, e.g., handovers for the UE between base stations.

Second 5G communication system 160 may include various virtualized NFs that are similar to first 5G communication system 130, including, for example but not limited to, AMF 162, UDR 164, and NRF 167, to name a few. For example, AMF 162 may be the control node that processes the signaling between UEs, via base station 166 and second 5G communication system 160. AMF 162 may receive connection and mobility management tasks from UEs 104 and can handle connection and mobility management tasks, while forwarding session management tasks/messages to a SMF. AMF 162 may be in communication with UDM 165 over SBI for UDM 165, such as a Nudm interface. NRF 167, which provides for network function service registration, authorization, and discovery, and otherwise enables network functions to identity one another.

UDM 150, 165 provides services to other functions of the Service-Based Architecture (SBA), such as AMF 132, 162 and other network functions. UDM 150, 165 may store information in local memory. UDM 150, 165 may also store information externally, for example, within UDR 134, 164 respectively. UDM 150, 165 may provide authentication credentials while being employed by AMF 132, 162 to retrieve subscriber data and access registration context data.

Although the preceding description may provide examples based on 5G communication system, it should be appreciated that the concepts described therein may be applicable to other types of telecommunication networks, including 4G/LTE. For example, the concepts described herein may be applicable to legacy networks, such as, GPRS, CDMA, GSM, and/or other wireless technologies in which a UE may operate. For example, 4G communication system 120 may include network functions of the legacy types of telecommunication networks. GPRS core networks may include a SGSN configured to perform functions similar to MME 122. 4G communication system 120 may include or be communicably coupled to a SGSN 124 that communicates with the HSS 140 via a designated interface, such as, a Gr interface for routing information between the SGSN 124 and the HSS/HLR 140. In some GPRS core networks, an S4-SGSN is used for performing functions similar to MME 122. 4G communication system 120 may include or be communicably coupled to a S4-SGSN 126 that communicates with HSS 140 via a designated interface, such as a s6d interface used for exchange of authentication, location, and server information about subscribers between HSS 140 and S4-SGSN 126. GSM core networks include a Visitor Location Register (VLR) configured to perform functions similar to the MME 122 and a HLR performing functions similar to HSS 140. 4G communication system 120 may include or be communicably coupled to VLR 128 that communicates with HSS 140 via a designated interface, such as a D interface used for routing information between a VLR 128 and the HSS/HLR 140.

In the example illustrated in FIG. 1, the three private networks, including 4G communication system 120, first 5G communication system 130, and second 5G communication system 160, are assigned with the same PLMN ID because only one PLMN ID has been allocated for all the private networks in this region. In an example scenario when the UE 104 moves out of the communication system 120's base station 102's coverage, it may detect base station 166 and initiate an initial registration procedure because base station 166 broadcasts the same PLMN ID as what base station 106 (eNB) broadcasts, which is provisioned in UE 104's SIM/eSIM to be considered as home PLMN ID or equivalent PLMN ID. At this point, UE 104 may (mistakenly) determine that base station 166 belongs to a preferred network that it has a subscription to. In this example, UE 104 may rely on base station 166 and the corresponding 5G communication system 160 to handle UE 104's registration procedure. Additional detail on the communication process in the receiving network (e.g., 5G communication system 160) is further provided herein.

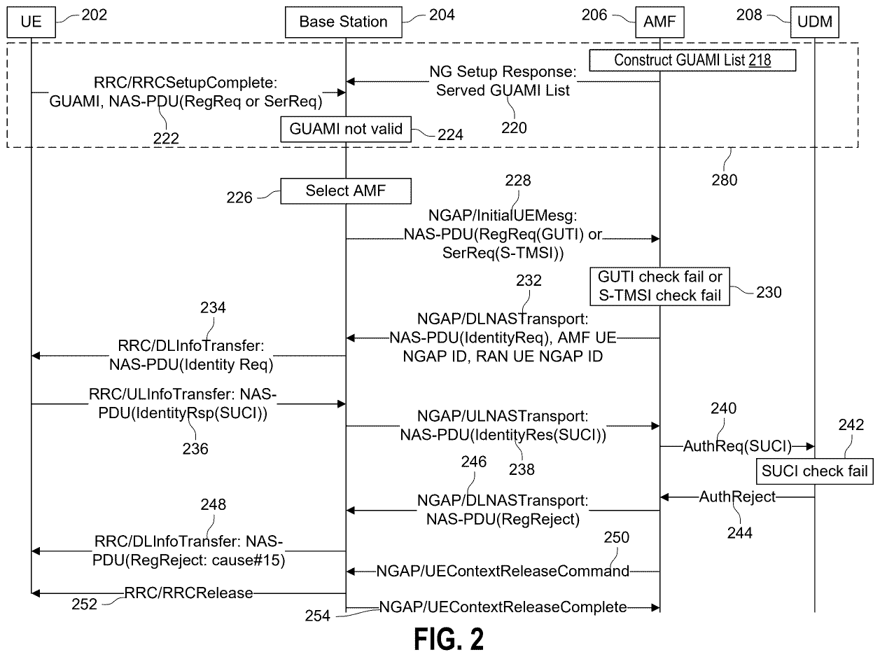

FIG. 2 illustrates an example message flow, in accordance with examples of the disclosed technology. In this example, a 5G communication system is illustrated, including UDM 208, AMF 206, base station 204, and UE 202, corresponding with UDM 165, AMF 162, base station 166, and UE 104 in FIG. 1, respectively. In this example, when UE 202 attempts to attach to the private network based on the detection of the network's PLMN ID that is broadcast by base station 204 for a private network, UE 202 is unable to determine if the broadcast PLMN ID belongs to a preferred network or to a private network that it does not have a subscription to. UE 202 may initiate attempts to acquire network access to the private networks that it does not belong, which may eventually fail. The attempts to acquire network access may include transmitting multiple unnecessary communications to those networks, which can be wasteful for over-the-air resources and processing capabilities of the network components (e.g., base station 204, AMF 206, and UDM 208) in those networks that are configured to process these requests.

For example, at block 218, AMF 206 may construct a GUAMI list. The GUAMI list may include the roaming partners' AMF and/or MME's identities. For example, AMF 206 may construct the GUAMI list that includes all identifiers of the AMFs that belong to this private network and the AMFs and/or MMEs of roaming partners' public or private networks that are interconnected with this private network (e.g., the roaming partner's networks). When a GUMMEI list is implemented, the GUMMEI of the MME may be mapped to the GUMMEI of the UE based on the operation specified in section 2.10.2 TS23.003.

At block 220, AMF 206 may transmit/serve the GUAMI list to base station 204 in a NG SETUP RESPONSE message. Since the GUAMI is included in a NG SETUP RESPONSE message from AMF 206, base station 204 may store the received value and use it for further AMF selection, as defined in TS 23.501 (block 226).

At block 222, UE 202 may transmit a RRC/RRC SETUP COMPLETE message to base station 204. RRC SETUP COMPLETE may identify that the Radio Resource Control (RRC) connection has been established and is complete. The RRC/RRC SETUP COMPLETE message may comprise the GUAMI and NAS-PDU message. The NAS message may comprise a Protocol Data Unit (PDU) session request or release to establish and release PDU sessions in 5G. The NAS-PDU message may correspond to a RegReq (registration request) message or SerReq (service request) message.

At block 224, base station 204 may determine that the GUAMI from UE 202 is not valid. For example, the GUAMI may not be valid when it is not included in the GUAMI list through a comparison operation at base station 204. However, as defined in TS 23.501, base station 204 may continue to select an AMF despite the invalidity of the GUAMI. Blocks 220, 222, and 224 may correspond to a first message flow process 280 that identifies, by base station 204, that the GUAMI received from UE 202 is not valid.

At block 226, base station 204 may initiate a selection process of an AMF, including AMF 206. Base station 204 may select AMF 206 based on factors like network slicing, UE capabilities, and location information. The selection of the AMF may help select which core network component will handle the registration and mobility management of UE 202 within the network.

At block 228, base station 204 may transmit NGAP/INITIAL UE MESG to AMF 206 to initiate the connection process. The NGAP/INITIAL UE MESG message may comprise a NAS-PDU RegReq message or SerReq message with an identification of UE 202. For example, when RegReq message is transmitted, the message may comprise a Globally Unique Temporary Identifier (GUTI) of UE 202. When SerReq message is transmitted, the message may comprise an S-Temporary Mobile Subscriber Identity (S-TMSI) of UE 202.

At block 230, AMF 206 may determine that the check procedure corresponding with the NAS-PDU RegReq message fails. For example, AMF 206 may determine that the GUTI check fails in response to the RegReq message or may determine that the S-TMSI check fails in response to the SerReq message.

At block 232, AMF 206 may transmit a NGAP/DL NAS TRANSPORT message to base station 204. The Downlink NAS Transport procedure may be used to send a NAS message transparently via base station 204 to UE 202. In this example, the NGAP/DL NAS TRANSPORT message may comprise a NAS-PDU with an IdentityReq, AMF UE NGAP-ID, and RAN UE NGAP ID.

At block 234, base station 204 may transmit a RRC/DL INFO TRANSFER message to UE 202. The message may deliver RRC configuration information to UE 202, which can instruct UE 202 on how to access the network and manage radio resources, including details like which cells to use and how to transmit data. The RRC/DL INFO TRANSFER message may comprise a NAS-PDU message with an IdentityReq.

At block 236, UE 202 may transmit a RRC/UL INFO TRANSFER message to base station 204. The RRC/UL INFO TRANSFER message may comprise a NAS-PDU message with an IdentityRsp comprising the Subscription Concealed Identifier (SUCI). UE 202 may derive the SUCI by using the provisioned public key of the Home PLMN (HPLM).

At block 238, base station 204 may transmit NGAP/UL NAS TRANSPORT message to AMF 206. The UL NAS TRANSPORT message may comprise a NAS-PDU message with an IdentityReq comprising the SUCI.

At block 240, AMF 206 may transmit an AuthReq with the SUCI to UDM 208.

At block 242, UDM 208 may determine that the SUCI check fails.

At block 244, UDM 208 may transmit an AuthReject to AMF 206.

At block 246, AMF 206 may transmit a NGAP/DL NAS TRANSPORT message to base station 204. The NGAP/DL NAS TRANSPORT message may comprise a NAS-PDU with a RegReject.

At block 248, base station 204 may transmit a RRC/DL INFO TRANSFER message to UE 202. The RRC/DL INFO TRANSFER message may comprise a NAS-PDU message with a RegReject message. The RegReject message may comprise Cause #15 as the reason for the rejection. The Cause #15 “No suitable cells in tracking area” to allow UE 602202 to try acquiring access to a network in different tracking areas, as specified in section 5.5.1.1 of TS 24.501.

At block 250, AMF 206 may transmit a NGAP/UE CONTEXT RELEASE COMMAND message to base station 204. AMF 206 can send the message to base station 204 to initiate the release of UE 202 context. This may instruct base station 204 to free up resources allocated to a specific UE on its network (UE 202).

At block 252, base station 204 may transmit a RRC/RRC RELEASE message to UE 202. For example, upon reception of the UE CONTEXT RELEASE COMMAND message, base station 204 may release all related signaling and user data transport resources.

At block 254, base station 204 may transmit a NGAP/UE CONTEXT RELEASE COMPLETE message to AMF 206.

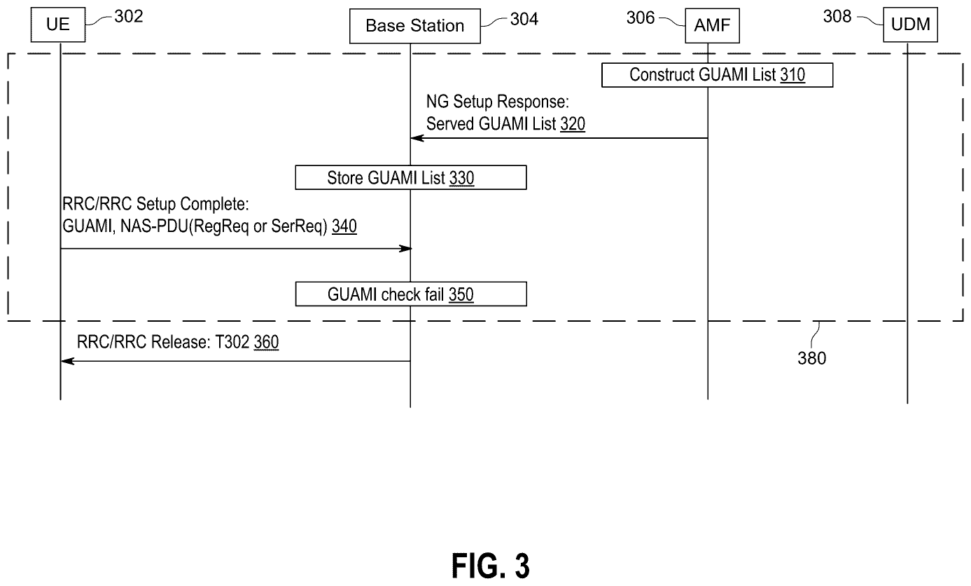

FIG. 3 illustrates an example message flow, in accordance with examples of the disclosed technology. In this example, a 5G communication system is illustrated, including UDM 308, AMF 306, base station 304, and UE 302, corresponding with UDM 208, AMF 206, base station 204, and UE 202 in FIG. 2, respectively.

In comparison to a first message flow process 280 in FIG. 2 and a second message flow process 380 in FIG. 3, both message flow processes may implement a GUAMI list that is generated by AMF 306 and stored at base station 304. However, in the second message flow process 380, the base station 304 may adjust its response to the GUAMI list by preventing base station 304 from selecting an AMF for a GUAMI that is not valid. Second message flow process 380 may additionally update rules implemented by base station 304 to access the GUAMI list when UE 302 attempts to setup/authenticate with the network and initiate a registration determination at base station 304, rather than AMF 306. By updating the first message flow process 280 in FIG. 2 to a second message flow process 380 in FIG. 3, additional messages within the message flow may be unnecessary and not sent via the network in second message flow process 380.

At block 310, AMF 306 may construct the GUAMI list including the roaming partners' AMF and/or MME's identities. For example, AMF 306 may construct the GUAMI list that includes all identifiers of the AMFs that belong to this private network and the AMFs and/or MMEs of roaming partners' public or private networks that are interconnected with this private network (e.g., the roaming partner's networks). When a GUMMEI list is implemented, the GUMMEI of the MME may be mapped to the GUMMEI of the UE based on the operation specified in section 2.10.2TS23.003.

In some examples, the GUAMI list may be used by AMF 306 to configure base station 304 with a full list of GUAMIs of all relevant AMFs. The configuration may utilize the NG Setup procedure or AMF Configuration Update procedure as specified in section 8.7.1 and section 8.7.3 of TS 38.413, respectively. In some examples, the GUAMI list may include the identities of the roaming partner networks' AMFs. This may help support UEs while roaming between various enterprise networks.

At block 320, AMF 306 may serve/transmit the GUAMI list to base station 304.

At block 330, base station 304 may store the GUAMI list.

At block 340, UE 302 may transmit a RRC/RRC SETUP COMPLETE message to base station 304. UE 302 may include the same GUAMI in the RRC SETUP COMPLETE message as specified in section 5.3.3.4 of TS 38.331. The RRC/RRC SETUP COMPLETE message may comprise the GUAMI and NAS-PDU message, as discussed with block 222 of FIG. 2.

At block 350, base station 304 may determine that the GUAMI from UE 302 is not valid. For example, if base station 304 does not recognize the GUAMI from UE 302, base station 304 may determine that UE 302 is a non-subscribing UE, and it should release this UE's RRC connection using the standardized RRC connection release procedure as defined in section 5.3.8 of TS 38.331.

In some examples, base station 304 may configure UE 302 to not attempt further network acquisition in the same base station's coverage. For example, base station 304 may include a waitTime parameter to set UE's T302 timer. The configuration of the T302 timer may be defined in section 7.1 of TS 38.331.

At block 360, base station 304 may transmit a RRC/RRC RELEASE MESSAGE to UE 302. The RRC RELEASE MESSAGE is a message that instructs UE 302 to enter an RRC idle state and may be sent over the PDCP protocol. For example, upon reception of the UE CONTEXT RELEASE COMMAND message, base station 304 may release all related signaling and user data transport resources and reply to AMF 306 with the UE CONTEXT RELEASE COMPLETE message. The RRC/RRC RELEASE message may comprise T302 as the reason for the release.

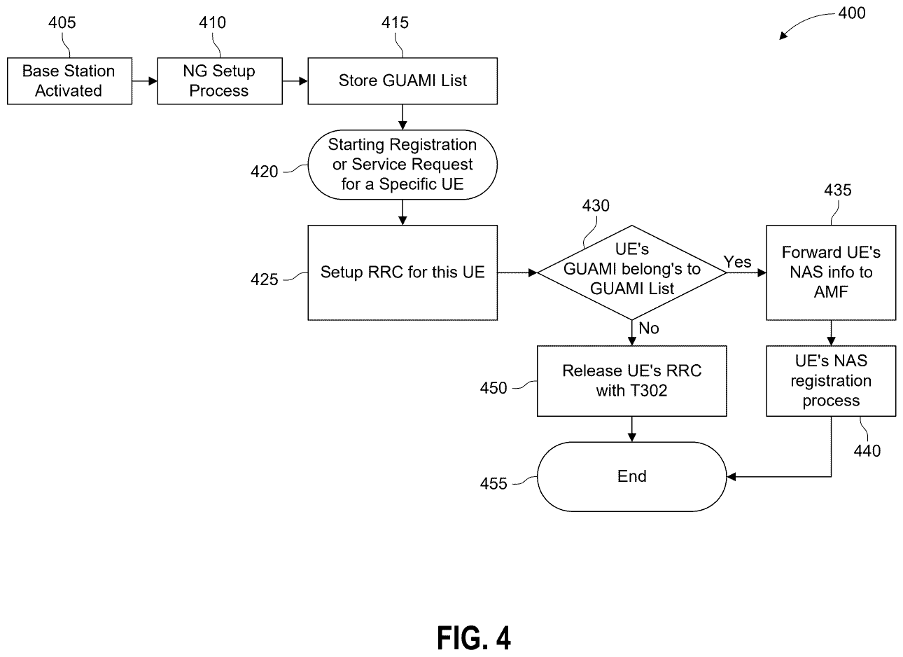

FIG. 4 illustrates an example registration process, in accordance with examples of the disclosed technology. In this example, a 5G communication system is illustrated. Blocks/steps illustrated herein are performed by any devices discussed herein, including AMF 206 in FIG. 2 or AMF 306 in FIG. 3.

At block 405, the process may activate the base station (e.g., via a network management system). For example, the base station may be physically connected to the network and the settings of the base station may be configured with cell information, the PLMN ID, and information for the 5G communication system (e.g., via the NF interface). The base station may initiate a registration process with the network, allowing it to start serving devices in its coverage area. In some examples, a network management system may configure the base station and its parameters based on the specific vendor and network setup.

At block 410, the process may initiate the NG SETUP PROCESS. For example, the NG SETUP REQUEST message may be sent from the base station to the AMF to request configuration data. The NG SETUP RESPONSE message may transmit/serve the GUAMI list from the AMF to the base station.

At block 415, the process may store the GUAMI list at the base station.

At block 420, the process may initiate a registration request or a service request from a specific UE. For example, the UE may transmit a RRC/RRC SETUP COMPLETE message to the base station, which identifies that the RRC connection has been established and is complete.

At block 425, the process may initiate an RRC for the specific UE. For example, the base station may identify the UE, allocate dedicated radio resources (e.g., SRB, DRB) and generate an RRC CONNECTION SETUP message. The message may be transmitted to the UE on an assigned downlink channel. The UE may send an RRC CONNECTION COMPLETE message to confirm the successful establishment of the RRC connection.

At block 430, the process may determine that the GUAMI received from the UE is included with the stored GUAMI list. For example, the GUAMI may not be valid when it is not included in the GUAMI list through a comparison operation at base station. If yes (e.g., the GUAMI is on the list), the process may proceed to block 435. If no (e.g., the GUAMI is not on the list), the process may proceed to block 450.

At block 435, the process may forward the NAS information for the UE to the AMF. For example, the base station may transmit NGAP/INITIAL UE MESG to the AMF, which comprises a NAS-PDU RegReq message or SerReq message with an identification of the UE. The RegReq message may comprise a GUTI of the UE and the SerReq message may comprise an S-TMSI of the UE.

At block 440, the NAS registration process may be initiated for the UE. When the registration process fails (e.g., the NAS-PDU RegReq message fails, etc.), the base station does not recognize the GUAMI from UE and the base station may determine that UE is a non-subscribing UE. In some examples, the base station may configure the UE to not attempt further network acquisition in the same base station's coverage.

At block 450, the process may release the RRC of the UE (e.g., using the RRC RELEASE MESSAGE). In some examples, the release may include a T302 code.

At block 455, the process may end.

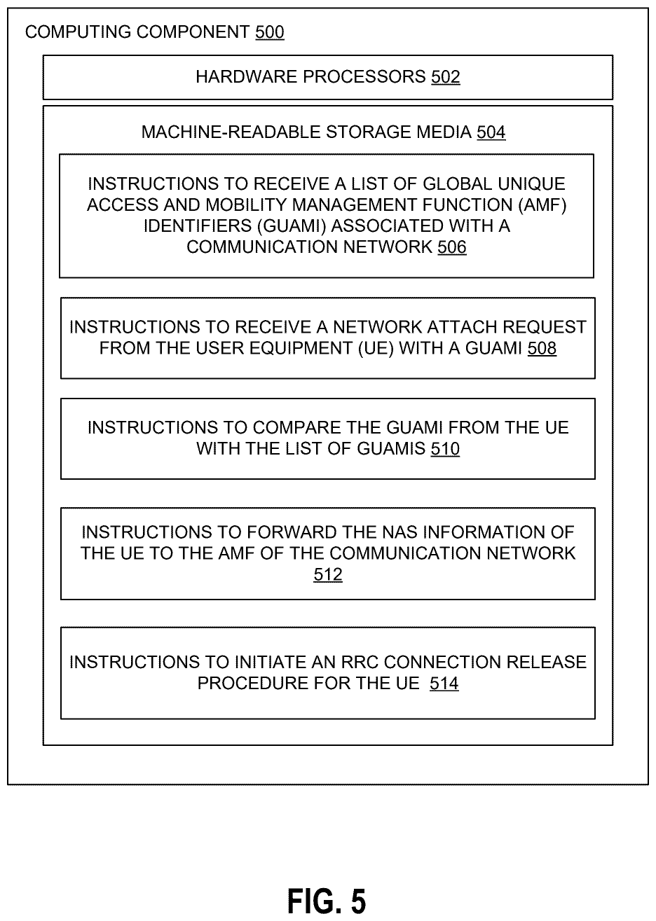

FIG. 5 illustrates a computing component 500 that may be used to execute instructions in accordance with examples of the disclosed technology. Computing component 500 may be, for example, a server computer, a controller, or any other similar computing component capable of processing data. In the example implementation of FIG. 5, computing component 500 includes a hardware processor 502 and machine-readable storage media 504. Computing component 500 may be used to embody, e.g., base station functionality in accordance with one example of the disclosed technology.

Hardware processor 502 may be one or more central processing units (CPUs), semiconductor-based microprocessors, and/or other hardware devices suitable for retrieval and execution of instructions stored in machine-readable storage media 504. Hardware processor 502 may fetch, decode, and execute instructions, such as instructions 506-514. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 504, may be any electronic, magnetic, optical, or other physical storage device that contains or stores executable instructions. Thus, machine-readable storage media 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 404 may be a non-transitory storage medium, where the term “non-transitory” does not encompass transitory propagating signals. As described in detail below, machine-readable storage media 504 may be encoded with executable instructions, for example, instructions 506-514.

Hardware processor 502 may execute instruction 506 to receive a list of GUAMIs associated with the communication network. The list may be received by a base station from the AMF in a communication network. In some examples, the AMF may construct the list of GUAMIs associated with the communication network. The AMF may provision the list of GUAMI to a plurality of base stations associated with the AMF.

Hardware processor 502 may execute instruction 508 to receive a network attach request from a UE. The network attach request may comprise NAS information of the UE. For example, the network attach request may be initiated when the UE is activated/turned on, reset, or other instances that allow the UE to request access to the network. In some examples, the network identifier associated with the UE may be the GUAMI of the AMF which the UE was registered to in a previous communication session.

Hardware processor 502 may execute instruction 510 to compare the GUAMI with the list of GUAMIs. For example, the AMF can be configured with the approved list of GUAMIs and can check if the UE's GUAMI belongs to the list of the supported ones.

Hardware processor 502 may execute instruction 512 to forward the NAS information to the AMF. The forwarding may be initiated in response to identifying the GUAMI in the list of GUAMIs. The NAS information can comprise a UE's GUAMI and the AMF may be specified by the UE in the NAS message that is routed to the AMF by the RAN. The AMF may authenticate the UE and manage handovers and other operations for the UE between access points and base stations.

Hardware processor 502 may execute instruction 514 to initiate an RCC connection release for the UE in response to identifying that the GUAMI is not on the list of GUAMIs. In some examples, the initiating of the RCC connection release for the UE may be performed immediately after the comparison absent contacting the AMF, UDM, and other devices.

By releasing UE, the UE may be prevented from transmitting multiple, unnecessary communications to the base station to attempt to acquire network access noted above. Accordingly, over-the-air resources and processing capabilities of the network components (e.g., the base station, AMF, and UDM) that are configured to process these requests are not wasted.

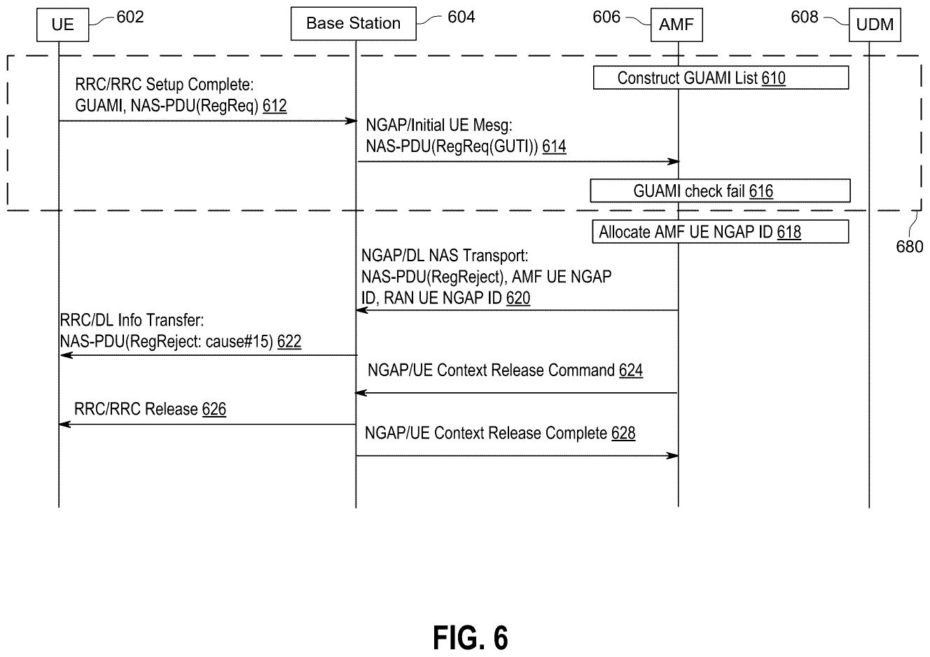

FIG. 6 illustrates an example message flow, in accordance with examples of the disclosed technology. In this example, a 5G communication system is illustrated, including UDM 608, AMF 606, base station 604, and UE 602, corresponding with UDM 150, AMF 132, base station 106, and UE 104 in FIG. 1, respectively. In comparison to a first message flow process 280 in FIG. 2 and a second message flow process 380 in FIG. 3, a third message flow process 680 in FIG. 6 may implement a GUAMI list that is generated by AMF 606 and also stored at AMF 606. The response from AMF 606 may be adjusted by preventing AMF 606 from contacting UDM 608 during the registration process.

Particularly, the third message flow process 680 may implement a GUAMI or GUMMEI list that is generated by and stored at AMF 606. The third message flow process 680 may configure UE 602 to exchange NAS information with AMF 606. The NAS information may be encapsulated in the RRCSetupComplete message over-the-air between UE 602 and base station 604 and in the Initial UE Message over NG interface between base station 604 and AMF 606, as specified in section 5.3.3.4 of TS 38.331 and section 8.6.1 of TS 38.413, respectively. The NAS information can comprise a 5G-GUTI of UE 602 that the UE obtains from a previous successful registration with its home PLMN. 5G-GUTI contains the GUAMI or GUMMEI information as specified in section 5.9.4 of TS 23.501. When AMF 606 receives the GUAMI from UE 602 (via base station 604), AMF 606 can determine the authorization of UE 602 earlier from the setup/authentication process, thereby reducing the number of messages between AMF 606 and UDM 608 and creating a more efficient registration process.

In some examples, AMF 606 can be configured with an approved list of GUAMIs and can check if the GUAMI of UE 602 belongs to the list of the supported ones. In case the GUAMI is not recognized, UE 602 can be rejected, without further consuming RAN or CN resources. The rejection may be implemented using Cause #15 “No suitable cells in tracking area” to allow UE 602 to try acquiring access to a network in different tracking areas, as specified in section 5.5.1.1 of TS 24.501.

At block 610, AMF 606 may construct the GUAMI list. For example, AMF 606 may construct the GUAMI list that includes an identifier of the AMF that the UE 602 was registered to in its previous 5G session.

At block 612, UE 602 may transmit a RRC/RRC SETUP COMPLETE message to base station 604. In this example, UE 602 can encapsulate the NAS information in the RRC SETUP COMPLETE message. The message may be encapsulated over-the-air between UE and base station, as specified in section 5.3.3.4 of TS 38.331. The RRC/RRC SETUP COMPLETE message may comprise the GUAMI and NAS-PDU message, as discussed with block 222 of FIG. 2.

At block 614, base station 604 may transmit NGAP/INITIAL UE MESSAGE to AMF 606. The GUAMI may be included in the INITIAL UE MESSAGE between base station 604 and AMF 606, as specified in section 8.6.1 of TS 38.413.

At block 616, AMF 606 may determine that the GUAMI from UE 602 is not valid and the GUAMI check may fail. For example, if AMF 606 does not recognize the GUAMI from UE 602, AMF 606 may determine that UE 602 is a non-subscribing UE, and it should release the UE's RRC connection using the standardized RRC connection release procedure, as defined in section 5.3.8 of TS 38.331.

At block 618, AMF 606 may allocate an AMF UE NGAP ID. The AMF UE NGAP ID may be a unique identifier assigned to UE 602 by AMF 606, allowing AMF 606 to specifically identify and manage UE 602 within its domain. In some examples, the identifier may be used for communication between AMF 606 and the 5G network's RAN via the NGAP protocol.

At block 620, AMF 606 may transmit NGAP/DL NAS TRANSPORT message to base station 604. The message may comprise NAS-PDU with RegReject, AMF UE NGAP ID (associated with UE 602), and RAN UE NGAP ID (associated with the NG-RAN node). The RAN UE NGAP ID and the AMF UE NGAP ID pair may provide a globally unique context reference for UE 602 across base station 604 and AMF 606.

At block 622, base station 604 may transmit RRC/DL INFO TRANSFER message to UE 602. The message may comprise NAS-PDU with RegReject listing Cause #15. Cause #15 may allow UE 602 to try acquiring access to a network in different tracking areas, as specified in section 5.5.1.1 of TS 24.501.

At block 624, AMF 606 may transmit NGAP/UE CONTEXT RELEASE COMMAND message to base station 604. For example, AMF 606 can send the message to base station 604 to initiate the release of UE 602 context. This may instruct base station 604 to free up resources allocated to a specific UE on its network (UE 602).

At block 626, base station 604 may transmit a RRC/RRC RELEASE message to UE 602. For example, upon reception of the UE CONTEXT RELEASE COMMAND message, base station 604 may release all related signaling and user data transport resources. Thus, by releasing UE's RRC connection, the UE 602 may be prevented from transmitting multiple, unnecessary communications to the base station 604 to attempt to acquire network access noted above. Accordingly, over-the-air resources and processing capabilities of the network components (e.g., base station 604, AMF 606, and UDM 608) that are configured to process these requests are not wasted.

In some examples, the base station 604 may configure the UE 602 to not attempt further network acquisition in the same base station coverage by including a waitTime parameter to set UE's T302 timer which is defined in section 7.1 of TS 38.331.

At block 628, base station 604 may transmit a NGAP/UE CONTEXT RELEASE COMPLETE message to AMF 606. When base station 604 transmits the NGAP/UE CONTEXT RELEASE COMPLETE message to AMF 606, base station 604 can communicate to AMF 606 that the base station has successfully released all UE context information related to a specific user. This can indicate that the UE is no longer connected to the network and its associated data on the base station has been cleared up, notifying the AMF to update its UE context accordingly.

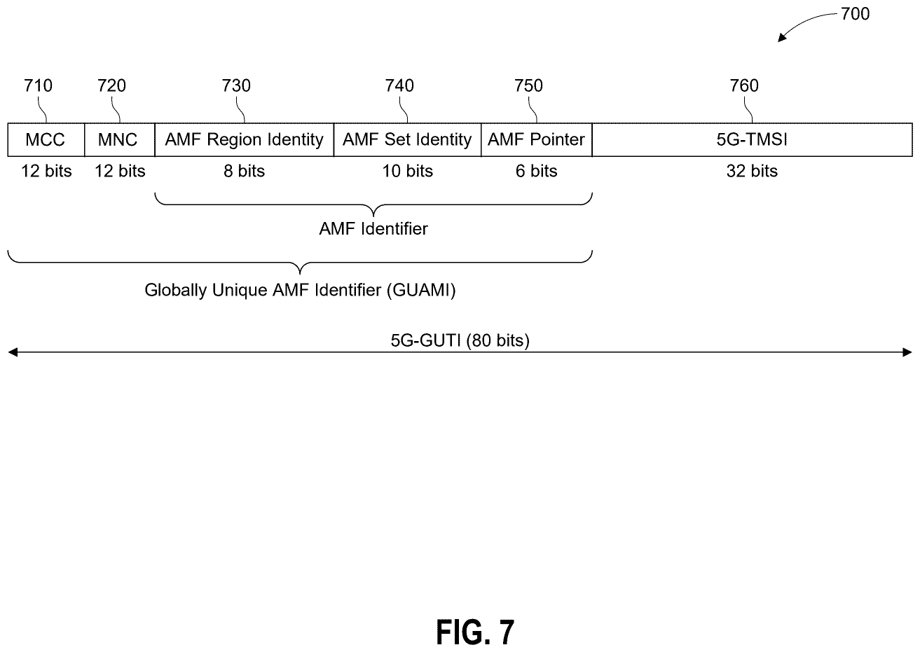

FIG. 7 is an illustrative 3GPP 5G-GUTI data format, in accordance with examples of the disclosed technology. In this example, the data format of a 5G-GUTI is provided. For example, the UE may obtain a 5G-GUTI from a previous successful registration with its home PLMN. The 5G-GUTI may be defined as MCC 710, MNC 720, AMF Region Identity 730 (the region that the UE is in), AMF Set Identity 740 (the AMF set within the AMF Region), AMF Pointer 750 (the AMFs within the AMF Set), and 5G-Temporary Mobile Subscriber Identity (5G-TMSI) 760.

The 5G-GUTI may also define other identifiers from portions of the data. For example, a first portion of the data may define a GUAMI, including MCC 710, MNC 720, AMF Region Identity 730, AMF Set Identity 740, and AMF Pointer 750. A second portion of the data may also define an AMF Identifier, including AMF Region Identity 730, AMF Set Identity 740, and AMF Pointer 750.

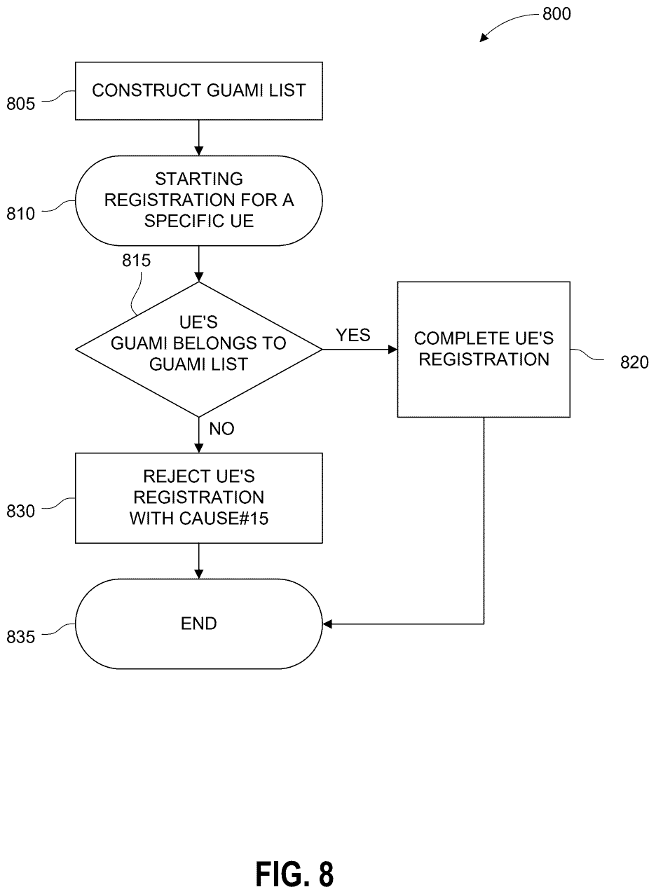

FIG. 8 illustrates an example registration process, in accordance with examples of the disclosed technology. In some examples, the AMF may implement the process illustrated herein in a 5G communication system. An illustrated AMF is provided as AMF 606 in FIG. 6.

At block 805, the process may construct a GUAMI list. For example, the AMF may construct the GUAMI list that includes an identifier of the AMF.

At block 810, the process may start registration for a specific UE. For example, the UE may provide a GUAMI that the UE was registered to in its previous 5G session. AMF may determine whether the GUAMI from the specific UE is valid or not. This may include a comparison of the GUAMI from the UE (received via the base station) with the GUAMIs in the GUAMI list.

At block 815, the process may determine that the UE's GUAMI belongs to the GUAMI list. This may include matching the GUAMI identifiers in an exact match. If there is a match, the process may proceed to block 820. If there is no match, the process may proceed to block 830.

At block 820, the process may complete the UE's registration. For example, the acceptance of the UE's registration attempt may provide the UE with the network-approved parameters for ongoing 5G service (identity, tracking areas, slices, timers, etc.).

At block 830, the process may reject the UE's registration with Cause #15. For example, if the AMF does not recognize the GUAMI from the UE, AMF may determine that the UE is a non-subscribing UE, and it should release the UE's RRC connection using the standardized RRC connection release procedure, as defined in section 5.3.8 of TS 38.331. Thus, the AMF can initiate the rejection of the UE's RRC connection and help prevent the UE from transmitting multiple, unnecessary communications to the RAN or CN resources. This can also help preserve over-the-air resources and processing capabilities of the network components.

At block 835, the process may end.

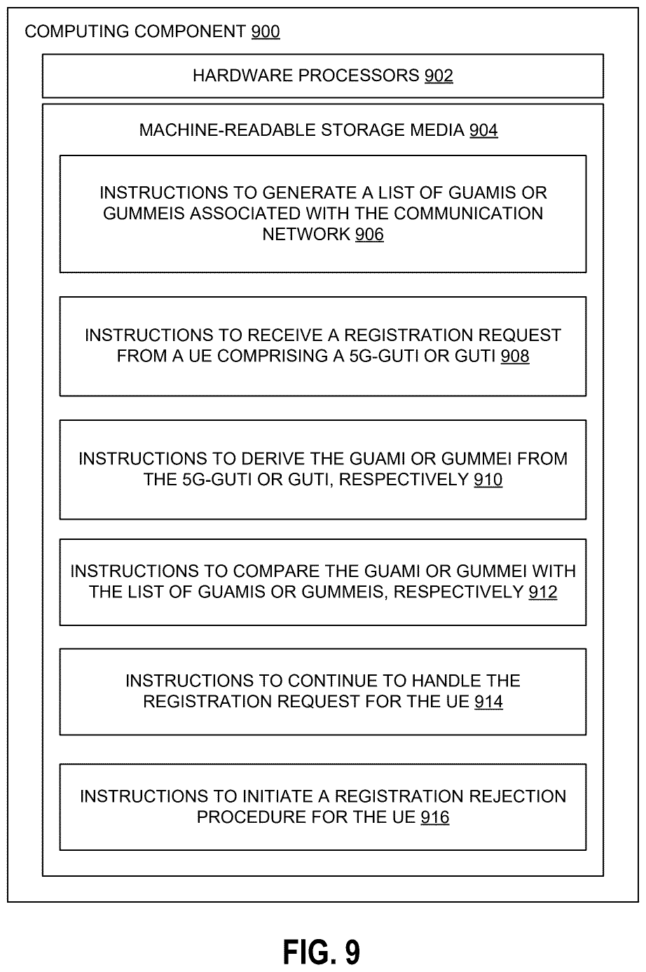

FIG. 9 illustrates a computing component that may be used to execute instructions in accordance with examples of the disclosed technology. Referring now to FIG. 9, computing component 900 may be, for example, a server computer, a controller, or any other similar computing component capable of processing data. In the example implementation of FIG. 9, computing component 900 includes a hardware processor 902, and machine-readable storage media 904. Computing component 900 may be used to embody, e.g., AMF functionality in accordance with one example of the disclosed technology.

Hardware processor 902 may be one or more central processing units (CPUs), semiconductor-based microprocessors, and/or other hardware devices suitable for retrieval and execution of instructions stored in machine-readable storage media 904. Hardware processor 902 may fetch, decode, and execute instructions, such as instructions 906-916. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 904, may be any electronic, magnetic, optical, or other physical storage device that contains or stores executable instructions. Thus, machine-readable storage media 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 404 may be a non-transitory storage medium, where the term “non-transitory” does not encompass transitory propagating signals. As described in detail below, machine-readable storage media 904 may be encoded with executable instructions, for example, instructions 906-916.

Hardware processor 902 may execute instruction 906 to generate a list of GUAMIs or GUMMEIs associated with the communication network. In some examples, the list of GUAMIs or GUMMEIs is generated by an AMF or MME in a communication network.

Hardware processor 902 may execute instruction 908 to receive a registration request from a UE. In some examples, the registration request is received by the AMF or the MME. The registration request may comprise a 5G-GUTI or a GUTI.

Hardware processor 902 may execute instruction 910 to derive the GUAMI or GUMMEI from the 5G-GUTI or GUTI. The GUAMI or GUMMEI may be derived by the AMF or the MME.

Hardware processor 902 may execute instruction 912 to compare the GUAMI or GUMMEI with the list of GUAMIs or GUMMEIs. The GUAMI or GUMMEI may be compared to the list by the AMF or the MME.

Hardware processor 902 may execute instruction 914 to continue to handle the registration request for the UE in the AMF or MME of the communication network. The continuation to handle the registration request may be initiated in response to identifying the GUAMI or GUMMEI in the list of GUAMIs or GUMMEIs.

Hardware processor 902 may execute instruction 916 to initiate a registration rejection procedure for the UE in the AMF or MME. The registration rejection procedure may be initiated in response to identifying that the GUAMI or GUMMEI is not on the list of GUAMIs or GUMMEIs. In some examples, initiating the registration rejection procedure for the UE may be performed immediately after the comparison absent contacting the AMF/MME, UDM, and other devices.

By initiating the registration rejection procedure, the UE may be prevented from transmitting multiple, unnecessary communications to the base station to attempt to acquire network access noted above. Accordingly, over-the-air resources and processing capabilities of the network components (e.g., the base station, AMF/MME, and UDM) that are configured to process these requests are not wasted.

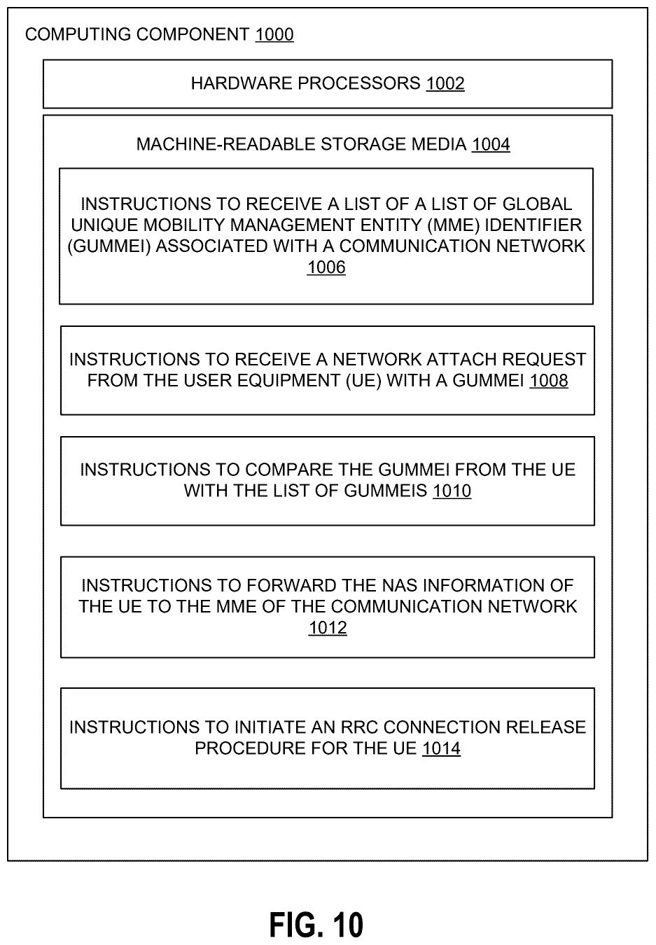

FIG. 10 illustrates a computing component 1000 that may be used to execute instructions in accordance with examples of the disclosed technology. Computing component 1000 may be, for example, a server computer, a controller, or any other similar computing component capable of processing data. In the example implementation of FIG. 10, computing component 1000 includes a hardware processor 1002 and machine-readable storage media 1004. Computing component 1000 may be used to embody, e.g., base station functionality in accordance with one example of the disclosed technology.

Hardware processor 1002 may be one or more central processing units (CPUs), semiconductor-based microprocessors, and/or other hardware devices suitable for retrieval and execution of instructions stored in machine-readable storage media 1004. Hardware processor 1002 may fetch, decode, and execute instructions, such as instructions 1006-1014. As an alternative or in addition to retrieving and executing instructions, hardware processor 1002 may include one or more electronic circuits that include electronic components for performing the functionality of one or more instructions, such as a field programmable gate array (FPGA), application specific integrated circuit (ASIC), or other electronic circuits.

Machine-readable storage media, such as machine-readable storage media 1004, may be any electronic, magnetic, optical, or other physical storage device that contains or stores executable instructions. Thus, machine-readable storage media 1004 may be, for example, Random Access Memory (RAM), non-volatile RAM (NVRAM), an Electrically Erasable Programmable Read-Only Memory (EEPROM), a storage device, an optical disc, and the like. In some examples, machine-readable storage media 1004 may be a non-transitory storage medium, where the term “non-transitory” does not encompass transitory propagating signals. As described in detail below, machine-readable storage media 1004 may be encoded with executable instructions, for example, instructions 1006-1014.

Hardware processor 1002 may execute instruction 1006 to receive a list of GUMMEI associated with the communication network. The list may be received by a base station from the MME in a communication network. In some examples, the MME may construct the list of GUMMEIs associated with the communication network. The MME may provision the list of GUMMEIs to a plurality of base stations associated with the MME.

Hardware processor 1002 may execute instruction 1008 to receive a network attach request from a UE. The network attach request may comprise NAS information of the UE. For example, the network attach request may be initiated when the UE is activated/turned on, reset, or other instances that allow the UE to request access to the network. In some examples, the network identifier associated with the UE is a GUMMEI of the AMF which the UE was registered to in a previous communication session.

Hardware processor 1002 may execute instruction 1010 to compare the GUMMEI with the list of GUMMEIs. For example, the MME can be configured with the approved list of GUMMEIs and can check if the UE's GUMMEI belongs to the list of the supported ones.

Hardware processor 1002 may execute instruction 1012 to forward the NAS information to the MME. The forwarding may be initiated in response to identifying the GUMMEI in the list of GUMMEIs. The NAS information can comprise a UE's GUMMEI and the MME may be specified by the UE in the NAS message that is routed to the MME by the RAN. The MME may authenticate the UE and manage handovers and other operations for the UE between access points and base stations.

Hardware processor 1002 may execute instruction 1014 to initiate an RCC connection release for the UE in response to identifying that the GUMMEI is not on the list of GUMMEIs. In some examples, the initiating of the RCC connection release for the UE may be performed immediately after the comparison absent contacting the MME, UDM, and other devices.

By releasing UE, the UE may be prevented from transmitting multiple, unnecessary communications to the base station to attempt to acquire network access noted above. Accordingly, over-the-air resources and processing capabilities of the network components (e.g., the base station, MME, and UDM) that are configured to process these requests are not wasted.

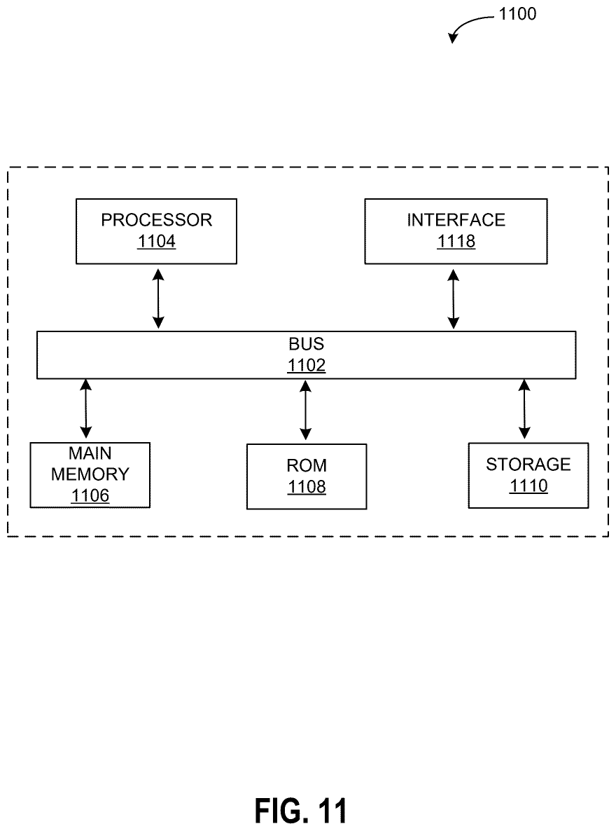

FIG. 11 depicts a block diagram of an example computer system 1100 in which various examples of the disclosed technology described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one example of the disclosed technology, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same. Non-transitory media is distinct from but may be used in conjunction with transmission media.

The computer system 1100 also includes interface 1118 coupled to bus 1102. Interface 1118 provides a two-way data communication coupling to one or more network links that are connected to one or more local networks. For example, interface 1118 may be an integrated services digital network (ISDN) card, cable modem, satellite modem, or a modem to provide a data communication connection to a corresponding type of telephone line. As another example, interface 1118 may be a local area network (LAN) card to provide a data communication connection to a compatible LAN (or WAN component to communicate with a WAN). Wireless links may also be implemented. In any such implementation, interface 1118 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving, by a base station from an Access and Mobility Management Function (AMF) in a communication network, a list of Global Unique AMF Identifiers (GUAMI) associated with the communication network;
receiving, by the base station, a network attach request from a User Equipment (UE), the network attach request comprising a Non-Access Stratum (NAS) information of the UE, a network identifier associated with the UE being the GUAMI of the AMF which the UE was registered to in a previous communication session;
comparing, by the base station, the GUAMI with the list of GUAMIs;
in response to identifying the GUAMI in the list of GUAMIs, forwarding, by the base station, the NAS information of the UE to the AMF of the communication network; and
in response to identifying that the GUAMI is not on the list of GUAMIs, initiating, by the base station, an RRC connection release procedure for the UE.

2. The method of claim 1, further comprising:
generating, by the AMF, the list of GUAMI associated with the communication network; and
provisioning, by the AMF, the list of GUAMI to a plurality of base stations associated with the AMF.

3. The method of claim 2, wherein the provisioning is implemented during a Next Generation (NG) setup procedure.

4. The method of claim 2, wherein the provisioning is implemented during a Next Generation (NG) configuration update procedure.

5. The method of claim 1, wherein the network attach request is triggered due to the UE performing a registration procedure.

6. The method of claim 1, wherein the network attach request is triggered due to the UE performing a service request procedure.

7. The method of claim 1, wherein the network identifier received from the UE is a native-type GUAMI of the AMF which the UE was registered to in a previous 5G communication session.

8. The method of claim 1, wherein the network identifier received from the UE is a mapped-type GUAMI of a Mobility Management Entity (MME) which the UE was registered to in a previous 4G communication session.

9. The method of claim 1, further comprising:
in response to not being on the list of GUAMIs, transmitting, by the base station to the UE, a waitTime to be used by the UE to set a T302 timer of the UE.

10. A method comprising:
receiving, by a base station from a Mobility Management Entity (MME) in a communication network, a list of Global Unique MME Identifier (GUMMEI) associated with the communication network;
receiving, by the base station, a network attach request from a User Equipment (UE), the network attach request comprising a Non-Access Stratum (NAS) information of the UE, a network identifier associated with the UE being a GUMMEI of an Access and Mobility Management Function (AMF) which the UE was registered to in a previous communication session;
comparing, by the base station, the GUMMEI with the list of GUMMEIs;
in response to identifying the GUMMEI in the list of GUMMEIs, forwarding, by the base station, the NAS information of the UE to the MME of the communication network; and
in response to identifying that the GUMMEI is not on the list of GUMMEIs, initiating, by the base station, an RRC connection release procedure for the UE.

11. The method of claim 10, further comprising:
generating, by the MME, the list of GUMMEI associated with the communication network; and
provisioning, by the MME, the list of GUMMEI to a plurality of base stations associated with the MME.

12. The method of claim 11, wherein the provisioning is implemented during a S1 setup procedure.

13. The method of claim 11, wherein the provisioning is implemented during a MME configuration update procedure.

14. The method of claim 10, wherein the network identifier received from the UE is a native-type GUMMEI of the MME which the UE was registered to in a previous 4G communication session.

15. The method of claim 10, wherein the network identifier received from the UE is a mapped-type GUMMEI of the AMF which the UE was registered to in a previous 5G communication session.

16. The method of claim 10, further comprising:
in response to not being on the list of GUMMEIs, transmitting, by the base station to the UE, a waitTime to be used by the UE to set a T302 timer of the UE.

17. A method comprising:
generating, by an Access and Mobility Management Function (AMF) or Mobility Management Entity (MME) in a communication network, a list of Global Unique AMF Identifiers (GUAMIs) or Global Unique MME Identifiers (GUMMEIs) associated with the communication network;
receiving, by the AMF or the MME, a registration request from a User Equipment (UE) comprising a 5G Globally Unique Temporary Identifier (5G-GUTI) or a Globally Unique Temporary Identifier (GUTI);
deriving, by the AMF or MME, the GUAMI or GUMMEI from the 5G-GUTI or GUTI, respectively;
comparing, by the AMF or MME, the GUAMI or GUMMEI with the list of GUAMIs or GUMMEIs;
in response to identifying the GUAMI or GUMMEI in the list of GUAMIs or GUMMEIs, continuing, by the AMF or MME, to handle the registration request for the UE in the AMF or MME of the communication network; and
in response to identifying that the GUAMI or GUMMEI is not on the list of GUAMIs or GUMMEIs, initiating, by the AMF or MME, a registration rejection procedure for the UE in the AMF or MME.

18. The method of claim 17, wherein the registration rejection procedure transmits a rejection message that comprises Cause 15 of No Suitable Cells in Tracking Area.

19. The method of claim 17, further comprising:
when the communication network that the AMF or MME belongs to supports roaming between 4G and 5G networks, the list of GUAMIs or GUMMEIs comprises mapped-type GUAMIs or GUMMEIs, respectively.

20. The method of claim 17, wherein the 5G-GUTI or GUTI is transmitted in Non-Access Stratum (NAS) information between the UE and the AMF or MME.
